(19) United States
(12) Patent Application Publication
(10) Pub. No.: US 2022/0170457 A1
(43) Pub. Date: Jun. 2, 2022

(54) ELECTRIC PUMP

(71) Applicant: NIDEC CORPORATION, Kyoto (JP)

(72) Inventor: Kaori MIYATA, Kyoto (JP)

(21) Appl. No.: 17/617,001

(22) PCT Filed: May 28, 2020
(86) PCT No.: PCT/JP2020/021079

§ 371 Date: Dec. 7, 2021

(30) Foreign Application Priority Data
Jun. 11, 2019 (JP) 2019-108377

(51) Int. Cl. F04C 2/10; F04C 15/00

(52) U.S. Cl. CPC F04C 2/10; F04C 15/0057

(57) ABSTRACT

An aspect of an electric pump of the present invention includes a motor unit having a rotor unit rotatable about a central axis and a stator unit facing the rotor unit, a pump unit located on one side in an axial direction of the stator unit, a circuit board electrically connected to the stator unit, and a motor housing having a motor accommodating portion that accommodates the motor unit. The pump unit includes a pump gear rotated by the rotor unit, and a pump housing provided with a pump chamber accommodating the pump gear. The motor housing includes a board accommodating portion that accommodates the circuit board. The board accommodating portion is located radially outside of the pump housing. The circuit board has a plate surface disposed along the axial direction. At least a part of the circuit board is located radially outside of the pump gear.

### CROSS-REFERENCE TO RELATED APPLICATIONS

This is the U.S. national stage of application No. PCT/JP2020/021079, filed on May 28, 2020, and priority under 35 U.S.C. § 119(a) and 35 U.S.C. § 365(b) is claimed from Japanese Patent Application No. 2019-108377, filed on Jun. 11, 2019.

### FIELD OF THE INVENTION

The present invention relates to an electric pump.

### BACKGROUND

An electric pump including a circuit board is known. For example, there is known an electric pump including a substrate provided in a driver unit that controls a motor unit.

In an electric pump, a circuit board may be disposed on one side in the axial direction of a motor unit. However, in this case, there has been a problem that the electric pump is upsized in the axial direction.

### SUMMARY

An exemplary electric pump of the present invention includes a motor unit having a rotor unit rotatable about a central axis and a stator unit facing the rotor unit in a radial direction with a gap interposed therebetween, a pump unit located on one side in an axial direction of the stator unit and driven by the motor unit through the rotor unit, a circuit board electrically connected to the stator unit, and a motor housing having a motor accommodating portion that accommodates the motor unit. The pump unit includes a pump gear rotated by the rotor unit, and a pump housing provided with a pump chamber accommodating the pump gear. The motor housing includes a board accommodating portion that accommodates the circuit board. The board accommodating portion is located radially outside of the pump housing. The circuit board has a plate surface disposed along the axial direction. At least a part of the circuit board is located radially outside of the pump gear.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a sectional view illustrating an electric pump of the present embodiment; and

FIG. 2 is a perspective view illustrating a part of the electric pump of the present embodiment.

### DETAILED DESCRIPTION

The Z-axis direction illustrated in each drawing is a vertical direction with the positive side defined as the “upper side” and the negative side defined as the “lower side”. The X-axis direction and the Y-axis direction illustrated in each drawing are horizontal directions orthogonal to the Z-axis direction, and are orthogonal to each other. A central axis J illustrated in each drawing is an imaginary line that is parallel to the Z axis and extends in the vertical direction. In the following description, an axial direction of the central axis J, that is, a direction parallel to the vertical direction is simply referred to as “axial direction”. A radial direction from the central axis J is simply referred to as “radial direction”. A circumferential direction about the central axis J is simply referred to as “circumferential direction”. A direction parallel to the X-axis direction is referred to as a “first horizontal direction X”, and a direction parallel to the Y-axis direction is referred to as a “second horizontal direction Y”.

In the following embodiment, the upper side corresponds to one side in the axial direction, and the lower side corresponds to the other side in the axial direction. Note that the terms, “vertical direction”, “horizontal direction”, “upper side”, and “lower side”, are merely used for describing arrangements and other relationships among constituent elements. The actual arrangements and other relationships may include those other than the relationships indicated by these terms.

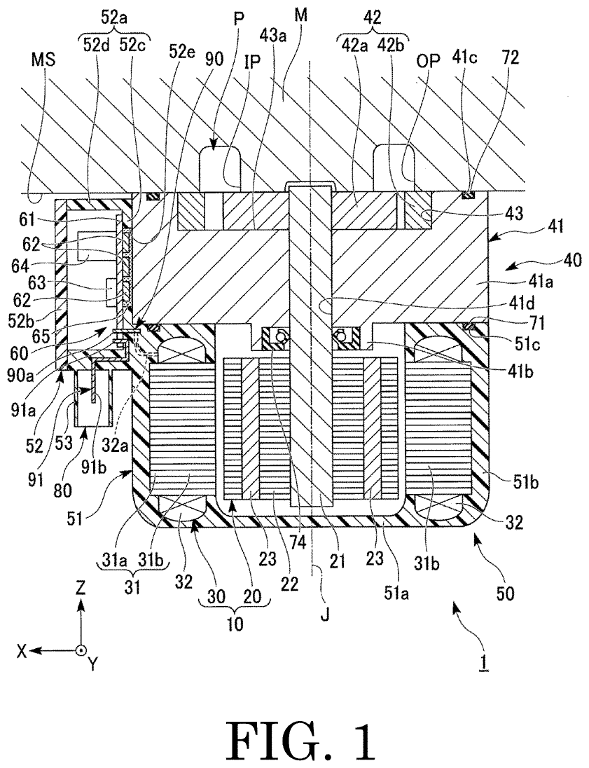

As illustrated in FIG. 1, an electric pump 1 of the present embodiment is attached to an attached body M having a flow path P through which a fluid flows. More specifically, the electric pump 1 is attached to an attached surface MS of the attached body M, the attached surface MS facing the lower side. A suction port IP and a discharge port OP of the flow path P open on the attached surface MS. The electric pump 1 uses a pump unit 40, to be described later, to suck the fluid from the suction port IP and discharges the fluid to the discharge port OP. The fluid sent by the electric pump 1 is not limited. The fluid is, for example, oil. Note that the fluid may be water.

The electric pump 1 includes a motor unit 10, the pump unit 40 driven by the motor unit 10, a motor housing 50 that accommodates the motor unit 10, a controller 60 that controls the motor unit 10, and a connector unit 80.

The motor unit 10 has a rotor unit 20 rotatable about the central axis J, a stator unit 30 facing the rotor unit 20 in the radial direction with a gap interposed therebetween, and a bus bar 90 electrically connected to the controller 60. The rotor unit 20 has a shaft 21, a rotor core 22, and a magnet 23. The shaft 21 is disposed along the central axis J. The shaft 21 has a columnar shape centered on the central axis J and extending in the axial direction. An upper portion of the shaft 21 penetrates the pump unit 40 in the axial direction.

The rotor core 22 is fixed to a lower portion of the shaft 21. The rotor core 22 is formed by, for example, laminating multiple plate members in the axial direction. The plate member is, for example, an electromagnetic steel plate. The magnet 23 is fixed to the rotor core 22. In the present embodiment, multiple magnets 23 are provided in the circumferential direction. In the present embodiment, the multiple magnets 23 are respectively fitted into multiple holes penetrating the rotor core 22 in the axial direction, and are fixed to the rotor core 22.

The stator unit 30 is located radially outside of the rotor unit 20. The stator unit 30 has a stator core 31 and multiple coils 32. The stator core 31 faces a radially outer surface of the rotor core 22 in the radial direction with a gap interposed therebetween. The stator core 31 has an annular core back 31a surrounding the rotor core 22 and multiple teeth 31b extending radially inward from the core back 31a. The multiple coils 32 are provided in the multiple teeth 31b. Each coil 32 is attached to each of the teeth 31b, for example, with an insulator, which is not illustrated, interposed therebetween.

The bus bar 90 is connected to a coil lead 32a drawn out from the coil 32. As a result, the bus bar 90 is electrically connected to the coil 32. One end portion 90a of the bus bar 90 is inserted into a hole provided in a circuit board 61 to be described later. Although not illustrated, the one end portion 90a is connected to the circuit board 61, for example, by soldering. Although not illustrated, multiple bus bars 90 are provided.

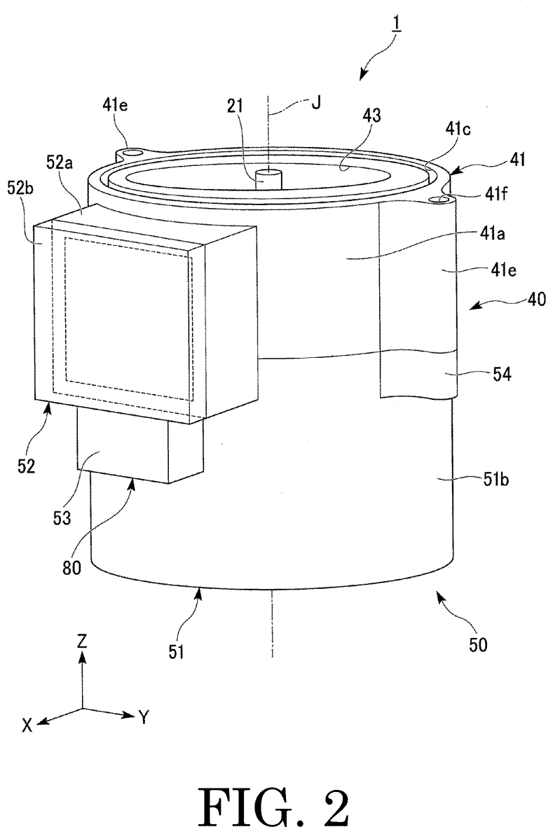

The pump unit 40 is located above the stator unit 30. The pump unit 40 has a pump housing 41 and a pump gear 42. The pump housing 41 is a member provided with a pump chamber 43 that accommodates the pump gear 42. In the present embodiment, the pump housing 41 is a heat sink. The pump housing 41 is made of metal such as aluminum. The pump housing 41 has a pump housing body 41a and a holder 41b. Note that the pump gear 42 is not illustrated in FIG. 2.

As illustrated in FIG. 2, in the present embodiment, the pump housing body 41a has a columnar shape centered on the central axis J. The pump chamber 43 is provided in an upper end portion of the pump housing body 41a. The pump chamber 43 is formed by a recess recessed downward from an upper surface of the pump housing body 41a. The shape of the pump chamber 43 as viewed from above is a circular shape in which the center is deviated from the central axis J in the radial direction. As illustrated in FIG. 1, in a state where the electric pump 1 is attached to the attached body M, an upper opening of the pump chamber 43 is closed by the attached surface MS. The inside of the pump chamber 43 is connected to the suction port IP and the discharge port OP.

The pump housing body 41a has a through hole 41d axially penetrating the pump housing body 41a. The through hole 41d extends in the axial direction about the central axis J. An upper end portion of the through hole 41d opens to a bottom surface 43a located on the lower side of an inner surface of the pump chamber 43. The shaft 21 is inserted into the through hole 41d. The shaft 21 is rotatably supported about the central axis J by an inner peripheral surface of the through hole 41d. An upper end portion of the shaft 21 protrudes into the pump chamber 43 through the through hole 41d.

A seal groove portion 41c recessed downward is provided on the upper surface of the pump housing body 41a, specifically in a portion located further outside, in the radial direction, as compared with the pump chamber 43. As illustrated in FIG. 2, the seal groove portion 41c has an annular shape centered on the central axis J. As illustrated in FIG. 1, an O-ring 72 is fitted into the seal groove portion 41c. In a state where the electric pump 1 is attached to the attached body M, the O-ring 72 seals a gap between the attached surface MS and the upper surface of the pump housing body 41a. As a result, it is possible to limit leakage of the fluid sent by the pump unit 40 to the outside of the electric pump 1. It is also possible to limit infiltration of water or the like into the pump chamber 43 from the outside of the electric pump 1.

The holder 41b protrudes downward from a lower surface of the pump housing body 41a. In the present embodiment, the holder 41b has a cylindrical shape centered on the central axis J and opening downward. Although not illustrated, the holder 41b surrounds the through hole 41d when viewed from below. A seal member 74 is held radially inward of the holder 41b.

The seal member 74 is in contact with an inner peripheral surface of the holder 41b and an outer peripheral surface of the shaft 21 to seal a gap between the inner peripheral surface of the holder 41b and the outer peripheral surface of the shaft 21. As a result, it is possible to keep the fluid flowing into the pump chamber 43 from flowing into a motor accommodating portion 51, to be described later, through the through hole 41d. The seal member 74 is located above the rotor core 22. The seal member 74 faces the rotor core 22 in the axial direction with a gap interposed therebetween. The seal member 74 is, for example, an oil seal.

As illustrated in FIG. 2, the pump housing 41 has a pair of attachment units 41e. The pair of attachment units 41e protrude radially outward from an outer peripheral surface of the pump housing body 41a. The pair of attachment units 41e extend in the axial direction from the upper end portion to a lower end portion of the pump housing body 41a. The pair of attachment units 41e are disposed so as to, for example, sandwich the central axis J in the second horizontal direction Y. Each of the pair of attachment units 41e has a through hole 41f axially penetrating the attachment unit 41e. Although not illustrated, a screw for fixing the electric pump 1 to the attached body M passes through the through hole 41f.

As illustrated in FIG. 1, the pump gear 42 is accommodated in the pump chamber 43. The pump gear 42 has an inner rotor 42a and an outer rotor 42b. The inner rotor 42a is connected to the upper end portion of the shaft 21, and is rotated about the central axis J by the shaft 21. The method of connecting the inner rotor 42a and the shaft 21 is not limited as long as the inner rotor 42a can be rotated by the shaft 21. For example, the upper end portion of the shaft 21 may be loose-fitted into a hole provided in the inner rotor 42a, and a D cut for preventing the shaft 21 from spinning around in the whole may be provided in the hole of the inner rotor 42a and the upper end portion of the shaft 21. Alternatively, the upper end portion of the shaft 21 may be press-fitted into a hole provided in the inner rotor 42a. Although not illustrated, the inner rotor 42a is an external gear having multiple tooth portions protruding radially outward.

The outer rotor 42b surrounds the radially outer side of the inner rotor 42a. Although not illustrated, the outer rotor 42b is an internal gear having multiple tooth portions protruding radially inward. The tooth portion of the inner rotor 42a and the tooth portion of the outer rotor 42b mesh with each other partially in the circumferential direction. Rotation of the inner rotor 42a by the shaft 21 also rotates the outer rotor 42b. That is, the pump gear 42 is rotated by the rotor unit 20.

In the pump unit 40, the inner rotor 42a and the outer rotor 42b rotate while meshing with each other in conjunction with the rotation of the shaft 21, thereby, to send the fluid from the suction port IP to the discharge port OP. That is, the pump unit 40 is driven by the motor unit 10 through the rotor unit 20.

In the present embodiment, the motor housing 50 is made of resin. The motor housing 50 has the motor accommodating portion 51, a board accommodating portion 52, and a connector tube portion 53. The motor accommodating portion 51 accommodates the motor unit 10. In the present embodiment, the motor accommodating portion 51 has a tubular shape that opens upward. An upper end portion of the motor accommodating portion 51 is fixed to a lower surface of the pump housing 41. The motor accommodating portion 51 has a bottom portion 51a and a tubular portion 51b.

The bottom portion 51a has a disk shape centered on the central axis J. The bottom portion 51a is located below the rotor unit 20. The bottom portion 51a covers the rotor unit 20 from below. An upper surface of the bottom portion 51a faces a lower end surface of the shaft 21 in the axial direction with a gap interposed therebetween.

The tubular portion 51b extends upward from a radially outer edge portion of the bottom portion 51a. In the present embodiment, the tubular portion 51b has a cylindrical shape centered on the central axis J. In the present embodiment, the stator unit 30 and the bus bar 90 are embedded and held in the tubular portion 51b. That is, the stator unit 30 and the bus bar 90 are embedded and held in the motor accommodating portion 51. In the present embodiment, the entire stator unit 30 and a part of the bus bar 90 are embedded in the tubular portion 51b.

In the present embodiment, a portion of the bus bar 90 excluding the one end portion 90a is embedded in the motor housing 50. The bus bar 90 is connected to the coil lead 32a at a portion thereof embedded in the motor housing 50. The one end portion 90a of the bus bar 90 extends radially outward and protrudes into the board accommodating portion 52. In the present embodiment, the one end portion 90a of the bus bar 90 protrudes radially outward from a support wall portion 52c. The one end portion 90a of the bus bar 90 protruding into the board accommodating portion 52 is connected to the circuit board 61.

An inner peripheral surface of the tubular portion 51b and a radially inner end surface of the teeth 31b are disposed at the same position in the radial direction. The radially inner end surface of the teeth 31b are exposed radially inward of the tubular portion 51b. The rotor core 22 and the magnet 23 are accommodated radially inward of the tubular portion 51b.

An upper end surface of the tubular portion 51b is in contact with a lower surface of the pump housing body 41a. A seal groove portion 51c recessed downward is provided on the upper end surface of the tubular portion 51b. Although not illustrated, the seal groove portion 51c has an annular shape centered on the central axis J. The outer diameter of the seal groove portion 51c is the same as the outer diameter of the seal groove portion 41c. The inner diameter of the seal groove portion 51c is the same as the inner diameter of the seal groove portion 41c. The seal groove portion 51c and the seal groove portion 41c overlap each other when viewed in the axial direction.

An O-ring 71 is fitted into the seal groove portion 51c. The O-ring 71 seals a gap between the upper end surface of the tubular portion 51b and the lower surface of the pump housing body 41a. As a result, it is possible to limit infiltration of water or the like into the motor accommodating portion 51 from the outside of the electric pump 1. The O-ring 71 and the O-ring 72 overlap each other when viewed in the axial direction. Hence, the same type of O-ring can be used as the O-ring 71 and the O-ring 72. As a result, the number of types of components of the electric pump 1 can be reduced, and the manufacturing cost of the electric pump 1 can be reduced.

The board accommodating portion 52 is a portion that accommodates the circuit board 61, to be described later, of the controller 60. In the present embodiment, the board accommodating portion 52 accommodates the entire controller 60. The board accommodating portion 52 extends upward from a radially outer surface at the upper end portion of the motor accommodating portion 51. The board accommodating portion 52 protrudes radially outward relative to the motor accommodating portion 51. In the present embodiment, the board accommodating portion 52 protrudes to one side in the first horizontal direction X.

The board accommodating portion 52 is located radially outside of the pump housing 41. The board accommodating portion 52 is fixed to a radially outer surface of the pump housing 41. More specifically, the board accommodating portion 52 is fixed to an outer peripheral surface of the pump housing body 41a. In a state where the electric pump 1 is attached to the attached body M, an upper end portion of the board accommodating portion 52 faces the attached surface MS with a gap interposed therebetween. As illustrated in FIG. 2, the board accommodating portion 52 has a rectangular parallelepiped shape.

The board accommodating portion 52 has an accommodating body 52a and a lid 52b. The accommodating body 52a has a rectangular parallelepiped box shape that opens radially outward. As illustrated in FIG. 1, the accommodating body 52a has the support wall portion 52c and a peripheral wall portion 52d. That is, the board accommodating portion 52 has the support wall portion 52c and the peripheral wall portion 52d. Of the wall portions forming the accommodating body 52a having a rectangular parallelepiped box shape, a wall portion located on the radially inner side is the support wall portion 52c is. The peripheral wall portion 52d is a wall portion extending radially outward from an outer edge portion of the support wall portion 52c.

A radially outer surface of the support wall portion 52c is in contact with the outer peripheral surface of the pump housing body 41a. That is, the support wall portion 52c is in contact with the radially outer surface of the pump housing 41. The support wall portion 52c has a hole 52e that penetrates the support wall portion 52c in the radial direction. The hole 52e is closed from the radially inner side by the outer peripheral surface of the pump housing body 41a. Electronic components such as a transistor 62, to be described later, are inserted into the hole 52e.

A heat conducting member 65 is provided in the hole 52e. In the present embodiment, the heat conducting member 65 is, for example, heat dissipating grease. The heat conducting member 65 is used, for example, to fill the entire hole 52e. The heat conducting member 65 is in contact with the circuit board 61, to be described later, the transistor 62, and the outer peripheral surface of the pump housing body 41a described later. In the present embodiment, the heat conducting member 65 closes and seals the hole 52e. As a result, it is possible to limit infiltration of water or the like into the board accommodating portion 52 from the outside of the electric pump 1.

The lid 52b is fixed to a radially outer end portion of the accommodating body 52a, that is, a radially outer end portion of the peripheral wall portion 52d. The lid 52b closes the opening of the accommodating body 52a. As illustrated in FIG. 2, the lid 52b has a rectangular plate shape. The lid 52b is fixed to the accommodating body 52a by, for example, thermal welding or the like.

As illustrated in FIGS. 1 and 2, the connector tube portion 53 protrudes downward from a lower wall portion of the peripheral wall portion 52d. The connector tube portion 53 has a rectangular parallelepiped box shape that opens downward. The connector tube portion 53 faces an outer peripheral surface of the motor accommodating portion 51 in the radial direction with a gap interposed therebetween. A lower end portion of the connector tube portion 53 is located above a lower end portion of the motor accommodating portion 51. The connector tube portion 53 forms a part of the connector unit 80.

As illustrated in FIG. 2, the motor housing 50 has an attachment unit 54. The attachment unit 54 protrudes radially outward from an upper end portion of the outer peripheral surface of the motor accommodating portion 51. Although not illustrated, a pair of the attachment units 54 are disposed, for example, so as to sandwich the central axis J in the second horizontal direction Y. The pair of attachment units 54 are located below the pair of attachment units 41e, respectively. Upper end portions of the pair of attachment units 54 are in contact with lower end portions of the pair of attachment units 41e, respectively. Although not illustrated, each of the pair of attachment units 54 has a through hole penetrating the attachment unit 54 in the axial direction. The through hole of the attachment unit 54 is connected to the through hole 41f of the attachment unit 41e. The attachment unit 41e and the attachment unit 54 are fastened together by fastening, to the attached body M, a screw inserted into the through hole from the lower side of the attachment unit 54. As a result, the motor housing 50 is fixed to the pump housing 41, and the electric pump 1 is attached to the attached body M.

In the present embodiment, the motor accommodating portion 51, the accommodating body 52a of the board accommodating portion 52, the connector tube portion 53, and the attachment unit 54 are integrally molded by insert molding in which a resin is poured into a mold into which the stator unit 30, the bus bar 90, and a terminal member 91, to be described later, are inserted. The lid 52b of the board accommodating portion 52 is formed separately from the accommodating body 52a. The lid 52b is fixed to the accommodating body 52a after the controller 60 is disposed inside the board accommodating portion 52.

The controller 60 has the circuit board 61, the transistor 62, a microcomputer 63, and a capacitor 64. That is, the electric pump 1 includes the circuit board 61, the transistor 62, the microcomputer 63, and the capacitor 64. The transistor 62, the microcomputer 63, and the capacitor 64 are electronic components mounted on the circuit board 61. The multiple coils 32 are electrically connected to the circuit board 61 through the bus bar 90. That is, the circuit board 61 is electrically connected to the stator unit 30. In the present embodiment, only one circuit board 61 is provided. Note that although not illustrated, electronic components such as a choke coil and a sensor may be mounted on the circuit board 61.

The circuit board 61 has a plate surface disposed along the axial direction. In the present embodiment, the plate surface of the circuit board 61 faces the radial direction. More specifically, the plate surface of the circuit board 61 is orthogonal to the radial direction. At least a part of the circuit board 61 is located radially outside of the pump gear 42. In the present embodiment, an upper end portion of the circuit board 61 is located radially outside of the pump gear 42.

As described above, according to the present embodiment, since the circuit board 61 is disposed radially outside of the pump unit 40, it is possible to limit upsizing of the electric pump 1 in the axial direction. Since the plate surface of the circuit board 61 extends along the axial direction, even if the circuit board 61 is disposed radially outside of the pump unit 40, the electric pump 1 is less likely to upsize in the radial direction. Since the circuit board 61 can be disposed at a position close to the radially outer surface of the pump housing 41, heat of the circuit board 61 and electronic components (e.g., transistor 62 and the like) to be mounted is easily released to the pump housing 41.

According to the present embodiment, the board accommodating portion 52 protrudes radially outward relative to the motor accommodating portion 51. Here, for example, in a case where the board accommodating portion 52 does not protrude radially outward relative to the motor accommodating portion 51, the motor accommodating portion 51 needs to be enlarged in the radial direction up to the position of the radially outer end of the board accommodating portion 52. On the other hand, since the board accommodating portion 52 is configured to protrude radially outward, the motor accommodating portion 51 does not need to be enlarged in the radial direction, and the radial dimension of the motor accommodating portion 51 can be reduced.

According to the present embodiment, the upper end portion of the motor accommodating portion 51 is fixed to the lower surface of the pump housing 41. Hence, the radial dimension of the electric pump 1 in the pump unit 40 can be reduced as compared with the case where the motor accommodating portion 51 covers the radially outer side of the pump housing 41. As described above, in the present embodiment, by protruding only the board accommodating portion 52 in the radial direction, the electric pump 1 can be reduced in the radial direction in a part other than the board accommodating portion 52. Accordingly, it is easy to downsize the electric pump 1 as a whole in the radial direction.

The circuit board 61 is in contact with the radially outer surface of the support wall portion 52c. That is, the support wall portion 52c supports the circuit board 61 from the radially inner side. In the present embodiment, the circuit board 61 closes the hole 52e from the radially outer side. In the present embodiment, a portion of the radially inner surface of the circuit board 61 facing the hole 52e comes into contact with the heat conducting member 65 filling the hole 52e. As a result, the circuit board 61 and the electronic components (e.g., transistor 62 and the like) mounted on the circuit board 61 are thermally connected to the pump housing 41 with the heat conducting member 65 interposed therebetween. Accordingly, the heat of the circuit board 61 and the electronic components (e.g., transistor 62 and the like) mounted on the circuit board 61 can be suitably released to the pump housing 41 which is a heat sink.

Note that in the present specification, “the circuit board is thermally connected to the pump housing” includes a case where the circuit board and the pump housing are in indirect contact with each other with the heat conducting member interposed therebetween, and a case where the circuit board is in direct contact with the pump housing. In the present specification, “the circuit board is thermally connected to the pump housing” includes a case where the circuit board and the pump housing are in indirect contact with each other with an electronic component (e.g., transistor 62 or the like) mounted on the circuit board interposed therebetween, and a case where the circuit board and the pump housing are in indirect contact with each other with an electronic component (e.g., transistor 62 or the like) mounted on the circuit board and the heat conducting member interposed therebetween.

In the present specification, “the electronic component mounted on the circuit board is thermally connected to the pump housing” includes a case where the electronic component and the pump housing are in indirect contact with each other with the heat conducting member interposed therebetween, and a case where the electronic component and the pump housing are in direct contact with each other. In the present specification, “the electronic component mounted on the circuit board is thermally connected to the pump housing” includes a case where the electronic component and the pump housing are in indirect contact with each other with the circuit board interposed therebetween, and a case where the electronic component and the pump housing are in indirect contact with each other with the heat conducting member and the circuit board interposed therebetween.

In the present embodiment, the circuit board 61 is in indirect contact with the radially outer surface of the pump housing 41 with the heat conducting member 65 interposed therebetween. Hence, the circuit board 61 accommodated in the board accommodating portion 52 is easily thermally connected to the pump housing 41, and the heat of the circuit board 61 is easily released to the pump housing 41. In the present embodiment, the circuit board 61 is in indirect contact with the radially outer surface of the pump housing 41 with the heat conducting member 65 and the transistor 62 interposed therebetween.

In the present embodiment, the lower end portion of the circuit board 61 is located radially outside of the coil 32. That is, at least a part of the circuit board 61 is located radially outside of the coil 32. Hence, it is easy to electrically connect the circuit board 61 and the coil 32 through the bus bar 90. According to the present embodiment, the board accommodating portion 52 has the accommodating body 52a that opens radially outward and the lid 52b that closes the opening of the accommodating body 52a. Hence, before the lid 52b is fixed to the accommodating body 52a, the circuit board 61 is inserted into the accommodating body 52a from the radially outer opening to connect the circuit board 61 and the one end portion 90a of the bus bar 90, so that the circuit board 61 can be easily connected to the coil 32. According to the present embodiment, since the motor housing 50 is made of resin, it is easy to allow the one end portion 90a of the bus bar 90 to protrude into the board accommodating portion 52 while embedding and holding a part of the bus bar 90 in the motor housing 50.

In the present embodiment, the entire circuit board 61 is located above the magnet 23. Hence, it is possible to keep the magnetic flux generated from the magnet 23 from affecting the circuit board 61. Although not illustrated, the circuit board 61 is fixed to the radially outer surface of the pump housing 41 with screws. The screws for fixing the circuit board 61 pass through the circuit board 61 and the support wall portion 52c and are fastened to the pump housing 41. As a result, the circuit board 61 and the board accommodating portion 52 are fastened together to the pump housing 41 with the screws.

The microcomputer 63 and the capacitor 64 are provided on the radially outer surface of the circuit board 61. The transistor 62 is provided in a portion of the radially inner surface of the circuit board 61 facing the hole 52e. That is, in the present embodiment, electronic components are mounted on both surfaces of the circuit board 61. Although not illustrated, in the present embodiment, a control circuit including a sensor and the like, which is not illustrated, is formed on the radially outer surface of the circuit board 61, and a drive circuit including the transistor 62 and the like is formed on the radially inner surface of the circuit board 61.

The drive circuit is likely to generate a larger amount of heat than the control circuit. Here, in the present embodiment, the surface of the circuit board 61 on which the drive circuit is provided is a surface facing the side where the pump housing 41 is located, that is, the radially inner surface. Hence, heat generated in the drive circuit is easily released to the pump housing 41. In particular, in the present embodiment, as described above, a portion of the radially inner surface of the circuit board 61 facing the hole 52e comes into contact with the heat conducting member 65 filling the hole 52e. Hence, heat generated in the drive circuit provided on the radially inner surface of the circuit board 61 can be suitably released to the pump housing 41 through the heat conducting member 65. As a result, heat can be more efficiently released from the circuit board 61 and the electronic components (e.g., transistor 62 and the like) mounted on the circuit board 61 to the pump housing 41.

The microcomputer 63 controls the transistor 62. In the present embodiment, multiple transistors 62 are provided. The multiple transistors 62 are disposed in the hole 52e. The transistor 62 is, for example, a field effect transistor (FET) or the like. The transistor 62 may form a part of an inverter that supplies power to the coil 32. In this case, the microcomputer 63 may control the inverter. The heat conducting member 65 is in contact with the surface of the transistor 62. Hence, the heat of the transistor 62 can be suitably released to the pump housing 41 through the heat conducting member 65.

The connector unit 80 protrudes downward from the board accommodating portion 52. The connector unit 80 has the connector tube portion 53 provided in the motor housing 50 and the terminal member 91. A part of the terminal member 91 is embedded and held inside the accommodating body 52a. One end portion 91a of the terminal member 91 protrudes radially outward from the support wall portion 52c and is connected to the circuit board 61 inside the board accommodating portion 52. The other end portion 91b of the terminal member 91 protrudes downward from a wall portion of the accommodating body 52a located on the lower side, and is disposed inside the connector tube portion 53. An external power supply, which is not illustrated, is connected to the connector unit 80. The external power supply is connected to the other end portion 91b of the terminal member 91, and supplies power to the motor unit 10 through the terminal member 91 and the controller 60.

The present invention is not limited to the above embodiment, and other structures may be adopted within the scope of the technical idea of the present invention. The arrangement of the circuit board is not limited as long as the plate surface of the circuit board is arranged along the axial direction, and at least a part of the circuit board is located radially outside of the pump gear. The entire circuit board may be located radially outside of the pump gear. The plate surface of the circuit board may be disposed along the axial direction and the radial direction and face the circumferential direction. A part of the circuit board may be located radially outside of the magnet of the rotor unit. The entire circuit board may be located above the multiple coils. The circuit board may be thermally connected to the pump housing by directly contacting the pump housing without interposing the heat conducting member. The circuit board does not have to be thermally connected to the pump housing. The circuit board may be fixed to the support wall portion by thermal welding or the like. An electronic component such as a transistor may be mounted on only one of both surfaces of the circuit board.

Multiple circuit boards may be provided. In this case, the multiple circuit boards may include a control board on which a sensor or the like is mounted and a drive board on which a transistor or the like is mounted. In this case, by disposing the drive board, which is likely to generate more heat than the control board, at a position close to the pump housing, heat can be efficiently released from the multiple circuit boards.

The heat conducting member may be heat dissipation grease having adhesiveness, such as a silicone adhesive. In this case, the circuit board and the pump housing can be bonded and fixed by the heat conducting member. The heat conducting member may be a heat conduction sheet. In this case, in order to seal the inside of the board accommodating portion, an O-ring surrounding the hole as viewed in the radial direction may be disposed between the radially inner surface of the support wall portion and the radially outer surface of the pump housing.

The material of the motor housing is not limited. The motor housing may be made of metal. The motor accommodating portion may extend higher than the motor accommodating portion 51 of the above-described embodiment to accommodate the pump unit. The board accommodating portion does not have to protrude radially outward relative to the motor accommodating portion. The board accommodating portion may be a member separate from the motor accommodating portion.

The electric pump according to the foregoing embodiment may be used for any purpose. The electric pump is mounted, for example, on a vehicle. The structures described in the present description can be combined as appropriate within a scope that does not give rise to mutual contraction.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. An electric pump comprising:
a motor unit that includes a rotor unit rotatable about a central axis and a stator unit facing the rotor unit in a radial direction with a gap interposed therebetween;
a pump unit that is located on one side in an axial direction of the stator unit and is driven by the motor unit through the rotor unit;
a circuit board electrically connected to the stator unit; and
a motor housing that has a motor accommodating portion that accommodates the motor unit, wherein
the pump unit includes
a pump gear rotated by the rotor unit, and
a pump housing provided with a pump chamber accommodating the pump gear,
the motor housing includes a board accommodating portion that accommodates the circuit board,
the board accommodating portion is located radially outside of the pump housing,
the circuit board has a plate surface disposed along the axial direction, and
at least a part of the circuit board is located radially outside of the pump gear.

2. The electric pump according to claim 1, wherein
the pump housing is a heat sink, and
the circuit board is thermally connected to the pump housing.

3. The electric pump according to claim 2, wherein
the board accommodating portion includes a support wall portion that supports the circuit board,
the support wall portion has a hole penetrating the support wall portion in the radial direction and is in contact with a radially outer surface of the pump housing,
a heat conducting member is provided in the hole, and
the circuit board is in indirect contact with the radially outer surface of the pump housing with the heat conducting member interposed therebetween.

4. The electric pump according to claim 1, wherein
the stator unit includes a plurality of coils electrically connected to the circuit board, and
at least a part of the circuit board is located radially outside of the coil.

5. The electric pump according to claim 4, wherein
the motor unit includes a bus bar electrically connected to the coil,
one end portion of the bus bar protrudes into the board accommodating portion and is connected to the circuit board, and
the board accommodating portion includes
an accommodating body that opens radially outward, and
a lid that closes the opening of the accommodating body.

6. The electric pump according to claim 5, wherein
the motor housing is made of resin, and
the stator unit and the bus bar are embedded and held in the motor accommodating portion.

7. The electric pump according to claim 1, wherein
the rotor unit includes
a rotor core, and
a magnet fixed to the rotor core, and
the entire circuit board is located closer to one side in the axial direction as compared with the magnet.

8. The electric pump according to claim 1, wherein
the board accommodating portion protrudes radially outward relative to the motor accommodating portion.

9. The electric pump according to claim 8, wherein
the motor accommodating portion has a tubular shape that opens to one side in the axial direction,
an end portion on one side in the axial direction of the motor accommodating portion is fixed to a surface on an other side in the axial direction of the pump housing, and
the board accommodating portion extends to one side in the axial direction from a radially outer surface at an end portion on the one side in the axial direction of the motor accommodating portion, and is fixed to a radially outer surface of the pump housing.
